(19) United States
(12) Patent Application Publication
(10) Pub. No.: US 2024/0309488 A1
(43) Pub. Date: Sep. 19, 2024

(54) METHOD FOR REDUCTIVE EXTRACTION OF IRIDIUM, RHODIUM AND/OR RUTHENIUM

(71) Applicant: Heraeus Deutschland GmbH & Co. KG, HANAU (DE)

(72) Inventors: Sybille OTT, Hanau (DE); Christoph RÖHLICH, Hanau (DE)

(21) Appl. No.: 18/263,465

(22) PCT Filed: Jan. 6, 2022
(86) PCT No.: PCT/EP2022/050191

§ 371 Date: Jul. 28, 2023

(30) Foreign Application Priority Data
Feb. 3, 2021 (EP) 21154929.0

(51) Int. Cl. C22B 11/00; C22B 3/10; C22B 3/46

(52) U.S. Cl. CPC C22B 11/042; C22B 3/10; C22B 3/46

(57) ABSTRACT

The invention relates to a method for reductive extraction of elemental noble metal from an acidic aqueous solution containing noble metal, the method comprising the addition of non-noble metal including zinc and/or tin to the acidic aqueous solution containing noble metal to form a reaction mixture, wherein the dissolved noble metal includes iridium, rhodium and/or ruthenium, wherein the non-noble metal is added in a leaner-than-stoichiometric amount, and wherein the pH of the acidic aqueous solution containing noble metal prior to the addition of the non-noble metal is in the range of +0.8 to +3.0 and is also kept in this range in the reaction mixture.

The invention relates to a method for reductive extraction of iridium, rhodium and/or ruthenium in metallic form from an acidic aqueous solution.

The reductive extraction of elemental noble metal from strongly acidic aqueous solutions containing noble metal, for example having a pH of ≤0, by adding non-noble metal to such a solution is known to a person skilled in the art as so-called noble metal cementation.

In the course of wet-chemical noble metal recycling or wet-chemical noble metal refining, oxidation of the noble metal is often first carried out in the presence of hydrochloric acid, wherein the noble metal made water-soluble in the course thereof goes into aqueous solution. This is usually followed by separation of the noble metal(s) concerned by precipitation thereof in the form of sparingly soluble chlorido complexes. This produces acidic mother liquors with a low, but recoverable, aqueous dissolved noble metal content. The noble metal content in acidic, in particular hydrochloric, aqueous solution is largely recovered by reduction, for example by adding iron powder as reducing agent. In the case of iridium, but also rhodium and ruthenium, the difficulty lies in recovering these noble metals within a time frame that is customary for the process, i.e., with a reasonable duration and at the same time a high recovery rate. As a compromise, an economically and ecologically unsatisfactory loss of these noble metals is accepted in practice, i.e., a certain amount of iridium, but also of rhodium or ruthenium, is lost with the waste water for targeted recovery.

The object of the invention was to find an improved cementation method ensuring high retention of iridium, rhodium and ruthenium, respectively, without having to accept unreasonably long process times.

The object is achieved by a method for reductive extraction of elemental, i.e. metallic, noble metal from an acidic aqueous solution including dissolved noble metal, which is hereinafter also referred to as an “acidic aqueous solution containing noble metal”. The method comprises the addition of non-noble metal including zinc and/or tin to the acidic aqueous solution containing noble metal to form a reaction mixture. The dissolved noble metal includes iridium, rhodium and/or ruthenium. The non-noble metal is added in an amount which exceeds the amount stoichiometrically necessary to reduce the dissolved noble metal included in the acidic aqueous solution containing noble metal with respect to the elemental metal. The pH of the acidic aqueous solution containing noble metal, i.e., its pH prior to the start of the addition of the non-noble metal, is in the range of +0.8 to +3.0 and is also kept in this range in the reaction mixture.

In the method according to the invention, non-noble metal is added to the acidic aqueous solution containing noble metal and thus causes cementation of the iridium, rhodium and/or ruthenium by reduction, and optionally cementation of other dissolved noble metals included in the acidic aqueous solution containing noble metal.

The acidic aqueous solution containing noble metal can in particular be a solution or mother liquor obtained in the course of wet-chemical noble metal recycling or wet-chemical noble metal refining. In particular, the acidic aqueous solution containing noble metal can originate from wet-chemical noble metal recycling carried out by oxidizing noble metal in the presence of hydrochloric acid or from wet-chemical noble metal refining carried out by oxidizing noble metal in the presence of hydrochloric acid. However, the acidic aqueous solution containing noble metal may also originate from one or—as a mixture of acidic aqueous solutions containing noble metal—from a plurality of other sources; these may be, for example, solutions originating from noble metal processing such as appropriate pickling solutions, solutions originating from syntheses of compounds containing noble metal, electroplating bath solutions, electrolyte solutions from electrochemical processes, rinsing water from plant cleaning and rinsing water from ion exchange processes.

An important feature of the acidic aqueous solution containing noble metal as well as of the acidic aqueous phase is the comparatively high pH in the range of +0.8 to +3.0, preferably in the range of +1.0 to +2.5. The acidic aqueous solution containing noble metal may already have this pH originally or, starting from an originally lower or even negative pH, may be adjusted thereto or have been adjusted thereto, for example through the addition of base, such as alkali hydroxide. The pH in the range of +0.8 to +3.0 arises from the acid contained in the acidic aqueous solution containing noble metal. The acid usually includes hydrochloric acid, either as the only acid or in combination with one or more other inorganic acids, especially in combination with nitric acid.

As stated, the pH is kept in the range of +0.8 to +3.0 and preferably in the range of +1.0 to +2.5 also in the reaction mixture, i.e., during noble metal cementation. In other words, during the reduction reaction, i.e., over the entire period needed for adding the non-noble metal plus a reaction period permitted thereafter, the pH is kept in the range of +0.8 to +3.0 and preferably in the range of +1.0 to +2.5 in the reaction mixture, for example by measuring the pH continuously or at expediently selected time intervals, in conjunction with any necessary additional or follow-up dosing of acid, in particular hydrochloric acid. The additional or follow-up dosing of acid may be necessary as a result of acid consumption during the reaction of acid with the added non-noble metal, which reaction is accompanied by the release of hydrogen. Measurements of pH values at expediently selected time intervals, as well as any pH adjustments that may be necessary, can be carried out, for example, at regular, short time intervals, for example at 10 to 15 minute intervals. This ensures that the actual pH deviates only in a harmless manner from the target pH defined within the range of +0.8 to +3.0, even in the event of any fluctuations leaving the target pH range for a short time.

The concentration of the dissolved iridium, rhodium and/or ruthenium in the acidic aqueous solution containing noble metal can, for example, be in the range of 30 to 10000 mg per liter or, for example, only 30 to 5000 mg per liter. It is clear to a person skilled in the art that this is the concentration before the reduction starts, i.e., before the non-noble metal is added. The concentration in this case decreases as said non-noble metal is progressively added repeatedly and as reduction or cementation progresses in the acidic aqueous phase of the reaction mixture.

The dissolved noble metal includes iridium, rhodium and/or ruthenium, and it can also include one or more other noble metals such as gold, palladium, platinum, osmium and silver. On the other hand, the dissolved noble metal can also consist of iridium, rhodium and/or ruthenium. The advantages of the method according to the invention are particularly apparent with respect to iridium and the extraction or recovery thereof; in this respect, the dissolved noble metal preferably includes, in particular, iridium or consists thereof.

In particular, the dissolved noble metal can be present substantially as a chlorido complex in the acidic aqueous solution containing noble metal. “Chlorido complex” in this context means hexachlorido complex or noble metal complexed with one or up to five chlorido ligands, wherein the noble metal can at the same time also be complexed with other complex ligands stable in an acidic aqueous environment. Examples of other complex ligands that are stable in an acidic aqueous environment include, in particular, water itself and chelating agents. Basic chelating agents such as DETA (diethylenetriamine) are of course present in protonated form. The expression “substantially as a chlorido complex” means that, optionally, a small portion, for example up to 1 mol %, of the dissolved noble metal may be present in a form other than as a chlorido complex.

In addition to water, dissolved noble metal and acid, the acidic aqueous solution containing noble metal can also contain other dissolved ingredients. Examples include dissolved non-noble metal as well as free ligands capable of complex or chelate formation, such as the aforementioned, albeit protonated, DETA.

As already stated, in the method according to the invention, non-noble metal including zinc and/or tin is added to the acidic aqueous solution containing noble metal. Zinc is preferred over tin in this respect. The non-noble metal can also include other non-noble metal, in particular iron, in addition to zinc and/or tin. The non-noble metal can include, for example, 20 to 100 wt % (% by weight) zinc and/or tin. It preferably includes 40 to 100 wt %, in particular 80 to 100 wt % zinc and/or tin. Especially preferably, the added non-noble metal consists of zinc and/or tin.

The non-noble metal is preferably in the form of powders, chips and/or granules. Preferred are powders, in particular those with absolute grain sizes, for example, in the range of 10 μm to 1.5 mm, in particular in the range of 10 to 70 μm.

The non-noble metal is added in a leaner-than-stoichiometric manner in the sense that it is added in an amount which exceeds the amount stoichiometrically necessary to reduce the dissolved noble metal included in the acidic aqueous solution containing noble metal with respect to the elemental metal. For example, a 5- to 100-fold stoichiometric excess of non-noble metal can be used.

Carrying out the method according to the invention requires a timescale of, for example, 3 to 48 hours, preferably 6 to 24 hours, in particular 6 to 12 hours, and includes the reduction reaction or noble metal cementation over the entire period needed for adding the non-noble metal plus a reaction period permitted thereafter of, for example, one hour before the reductively extracted noble metal can be separated from the reaction mixture in the subsequent step. The actual addition of the non-noble metal is preferably carried out uniformly and can last for a period of, for example, 2 to 47 hours. The uniform addition can, for example, be carried out continuously following a trickle principle similar to the operation of an hourglass, or in small uniform portions in each case at uniform time intervals, for example at 10 to 15 minute intervals. The addition and/or the reduction and cementation process thereby initiated is expediently continued until the noble metal cementation has abated and progressed to such an extent that further processing no longer appears to be economically viable.

The temperature of the reaction mixture of the acidic aqueous solution containing noble metal and the added non-noble metal is expediently in the range of, for example, 55 to 90° C., preferably 70 to 85° C. In other words, the reaction temperature is expediently in the range of, for example, 55 to 90° C., preferably 70 to 85° C.

During the addition period and thereafter, the acidic aqueous solution containing noble metal or the reaction mixture is expediently mixed, for example stirred.

The metallic iridium, rhodium and/or ruthenium formed by reduction precipitates out as a precipitate and can be separated, for example by filtration. It is expedient to wait until the non-noble metal has been substantially or completely dissolved before separation. This can take place, for example, during the reaction period permitted after the last addition of the non-noble metal.

The method according to the invention makes it possible to extract iridium, rhodium and/or ruthenium while ensuring high retention and without having to accept undesirably and unusually long process times.

### EXAMPLES

### General Procedure

A hydrochloric acid aqueous solution containing noble metal was optionally adjusted with 17 M NaOH to a higher pH than its original pH, i.e., to the specified target pH. Subsequently, the temperature of the solution was raised to the specified value and, by stirring, the addition of reducing agent in the form of iron, zinc or tin powder in small uniform portions (spatula tip) was started. The metal powder was added every 15 minutes for the specified period, in total at least 10 times leaner than stoichiometric in each case. During the noble metal cementation, the pH was continuously monitored and repeatedly lowered to the desired pH with 10 M HCl, since the pH kept rising as the addition of the metal powder progressed. After the last addition of the metal powder, the solution was stirred for another 1 hour and then allowed to settle. The cooled solution was filtered off and submitted for analysis.

### Example 1

500 ml of a hydrochloric acid solution with an original pH of −0.8 and with an iridium content of 24 mg Ir per liter, a rhodium content of 31 mg Rh per liter and a ruthenium content of 1781 mg Ru per liter were treated according to the general procedure at a target pH of +1.0 at a temperature of 85° C. for a total of 7 hours.

| | Yield of | Yield of | Yield of |
|---|---|---|---|
| | iridium in | rhodium in | ruthenium |
| Reducing agent | mg | mg | in mg |
| Iron powder | 2.6 | 3.5 | 17.9 |
| Zinc powder | 6.1 | 10.1 | 373.6 |
| Tin powder | 5.7 | 6.6 | 284.7 |

### Example 2

200 ml of a hydrochloric acid solution with an original pH of −0.8 and with an iridium content of 91 mg Ir per liter were treated with zinc powder (the zinc powder was added for 6 hours plus 1 hour post-reaction) according to the general procedure at the specified target pH and at a temperature of 85° C. for a total of 7 hours.

| | Yield of iridium in |
|---|---|
| pH | mg |
| +1.0 | 17.40 |
| +3.0 | 15.54 |

### Example 3

500 ml of a hydrochloric acid solution with an original pH of −0.9 and with an iridium content of 100 mg Ir per liter were treated with zinc powder (the zinc powder was added for 2 hours plus 1 hour post-reaction) according to the general procedure at the specified pH and at a temperature of 85° C. for a total of 3 hours.

| | Yield of iridium in |
|---|---|
| pH | mg |
| −0.9 | 12.56 |
| +1.0 | 38.98 |

### Example 4

200 ml of a hydrochloric acid solution with an original pH of −0.8 and with an iridium content of 94 mg Ir per liter were treated according to the general procedure at a target pH of +1.0 and at a temperature of 85° C. by adding zinc powder over the specified time period.

| | Yield of iridium |
|---|---|
| Addition period | in mg |
| 2 hours | 13.47 |
| 6 hours | 15.14 |

### Example 5

200 ml of a hydrochloric acid solution with an original pH of −0.8 and with an iridium content of 94 mg Ir per liter were treated with zinc powder (the zinc powder was added for 6 hours plus 1 hour post-reaction) according to the general procedure at a target pH of +1.0 for a total of 7 hours at the specified temperature.

| | Yield of iridium in |
|---|---|
| Temperature | mg |
| 55° C. | 14.12 |
| 85° C. | 15.14 |

1. A method for reductive extraction of elemental noble metal from an acidic aqueous solution including dissolved noble metal, the method comprising the addition of non-noble metal to the acidic aqueous solution including dissolved noble metal to form a reaction mixture,
wherein the dissolved noble metal includes iridium, rhodium and/or ruthenium,
wherein the non-noble metal includes zinc and/or tin,
wherein the non-noble metal is added in an amount which exceeds the amount stoichiometrically necessary to reduce the dissolved noble metal included in the acidic aqueous solution including dissolved noble metal with respect to the elemental metal, and wherein the pH of the acidic aqueous solution including dissolved noble metal prior to the addition of the non-noble metal is in the range of +0.8 to +3.0 and is also kept in this range in the reaction mixture.

2. The method according to claim 1, wherein the acidic aqueous solution including dissolved noble metal is a solution or mother liquor obtained in the course of wet-chemical noble metal recycling or wet-chemical noble metal refining.

3. The method according to claim 1, wherein the acidic aqueous solution including dissolved noble metal originates from wet-chemical noble metal recycling carried out by oxidizing noble metal in the presence of hydrochloric acid or from wet-chemical noble metal refining carried out by oxidizing noble metal in the presence of hydrochloric acid.

4. The method according to claim 1, wherein the acidic aqueous solution including dissolved noble metal is a solution or a mixture of a plurality of solutions selected from the group consisting of pickling solutions originating from noble metal processing, solutions originating from syntheses of compounds containing noble metal, electroplating bath solutions, electrolyte solutions from electrochemical processes, rinsing water from plant cleaning and rinsing water from ion exchange processes.

5. The method according to claim 1, wherein the pH is in the range of +1.0 to +2.5.

6. The method according to claim 1, wherein the acidic aqueous solution including noble metal includes hydrochloric acid as the only acid or in combination with one or more other inorganic acids.

7. The method according to claim 1, wherein the concentration of the dissolved iridium, rhodium and/or ruthenium in the acidic aqueous solution including dissolved noble metal prior to the start of the addition of the non-noble metal is in the range of 30 to 10000 mg per liter.

8. The method according to claim 1, wherein the dissolved noble metal includes one or more other noble metals in addition to iridium, rhodium and/or ruthenium, or consists of iridium, rhodium and/or ruthenium.

9. The method according to claim 1, wherein the non-noble metal is in the form of powder, chips and/or granules.

10. The method according to claim 1, wherein the non-noble metal can also include other non-noble metal in addition to zinc and/or tin.

11. The method according to claim 1, wherein the non-noble metal includes 20 to 100 wt % zinc and/or tin.

12. The method according to claim 1, wherein a 5- to 100-fold stoichiometric excess of non-noble metal is used.

13. The method according to claim 1, wherein the non-noble metal is added uniformly.

14. The method according to claim 1, wherein the non-noble metal is added over a period of 2 to 47 hours.

15. The method according to claim 1, wherein the temperature of the reaction mixture of the acidic aqueous solution including dissolved noble metal and the added non-noble metal is in the range of 55 to 90° C.
